(19) United States
(12) Patent Application Publication
(10) Pub. No.: US 2015/0176199 A1
(43) Pub. Date: Jun. 25, 2015

(54) METHOD FOR MANUFACTURING AN ELEMENT OF COMPOSITE MATERIAL COMPRISING A NON- CRIMP FABRIC AND POLYETHERIMIDE (PEI) AND AN ELEMENT OF COMPOSITE MATERIAL OBTAINED THEREWITH

(71) Applicant: TEN CATE ADVANCED COMPOSITES B.V., Nijverdal (NL)

(72) Inventors: Robertus Gerardus Lenferink, Tubbergen (NL); Roger De Leeuw, Almelo (NL)

(21) Appl. No.: 14/408,185

(22) PCT Filed: Jun. 17, 2013
(86) PCT No.: PCT/NL2013/050429

§ 371 Date: Dec. 15, 2014

(30) Foreign Application Priority Data
Jun. 15, 2012 (NL) 2009017

(51) Int. Cl. D06M 15/53; C03C 25/00; D06M 15/59

(52) U.S. Cl. CPC D06M 15/53; D06M 15/59; C03C 25/007; D06M 2101/40

(57) ABSTRACT

The invention relates to a method for manufacturing an element of composite material comprising a non-crimp fabric and polyetherimide (PEI), comprising the following steps, to be performed in suitable sequence, of: a) providing a non-crimp fabric; b) dissolving PEI in a solvent; c) arranging the solvent with PEI dissolved therein on the non-crimp fabric; d) pressing the solvent with PEI dissolved therein into the non-crimp fabric; e) heating the non-crimp fabric for the purpose of evaporating the solvent, wherein the PEI remains behind in the non-crimp fabric; and f) allowing the non-crimp fabric to cool and thus allowing the PEI to cure so as to obtain the element. The invention also relates to an element of composite material comprising a non-crimp fabric and polyetherimide (PEI) obtained by applying the method according to the invention, which element comprises a for instance plate-like or sheet-like body of PEI in which the non-crimp fabric is embedded as reinforcement.

The invention relates to a method for manufacturing an element of composite material comprising a non-crimp fabric and polyetherimide (PEI).

Because of its properties a composite comprising a non-crimp fabric and PEI is suitable for diverse high-grade purposes. Such a composite element is for instance suitable for manufacturing components of vehicles such as cars, trucks, boats, aircraft, helicopters and space vehicles. The manufacture of an element of composite material comprising a non-crimp fabric and PEI can take place using different, per se known methods. PEI can be arranged in different ways here in a non-crimp fabric in order to obtain an element of PEI in which the non-crimp fabric is embedded as reinforcement. The currently known methods each have their own specific drawbacks however, such as the high cost of for instance fine grinding of the PEI or being able to arrange the PEI only with difficulty in the non-crimp fabric because of the high viscosity of PEI.

It is an object of the invention to at least partially obviate the above stated drawbacks. It is a particular object of the invention to provide an alternative method with which an element of composite material comprising a non-crimp fabric and PEI can be manufactured in simple and/or relatively inexpensive and/or rapid manner and/or wherein a good impregnation of the PEI in the non-crimp fabric is obtained.

The method of the type stated in the preamble comprises for this purpose according to the invention the following steps, to be performed in suitable sequence, of:
a) providing a non-crimp fabric;
b) dissolving PEI in a solvent;
c) arranging the solvent with PEI dissolved therein on the non-crimp fabric;
d) pressing the solvent with PEI dissolved therein into the non-crimp fabric;
e) heating the non-crimp fabric for the purpose of evaporating the solvent, wherein the PEI remains behind in the non-crimp fabric; and
f) allowing the non-crimp fabric to cool and thus allowing the PEI to cure so as to obtain the element.

Because the PEI is dissolved in the solvent according to the invention, it is not necessary for the PEI to be ground fine, whereby costs can be saved.

The mixture of PEI and solvent has a lower viscosity than non-dissolved melted PEI, whereby the mixture can flow easily between separate filaments of the non-crimp fabric and arranging of the PEI in the non-crimp fabric can take place in simple manner, wherein a good impregnation of the PEI in the non-crimp fabric is obtained.

Step c) can for instance take place by drawing the non-crimp fabric through a bath filled with solvent having PEI dissolved therein. This non-crimp fabric drawn through the bath can subsequently be pulled in step d) through two pressure rollers disposed close to each other for the purpose of pressing the solvent with PEI dissolved therein into the non-crimp fabric. The two pressure rollers are disposed here at a predetermined distance from each other so that the non-crimp fabric with solvent and PEI dissolved therein will have a predetermined thickness.

It is noted that it will be apparent that in the method according to the invention it is the case that one layer of the non-crimp fabric is pressed in step d). Good impregnation takes place by pressing per layer and thereby pressing the solvent with PEI dissolved therein into the fabric, whereby the quality of the product can be enhanced.

In a method wherein a mixture of solvent with PEI dissolved therein is arranged separately on separate layers and wherein the layers are then pressed together to form a laminate, it may be the case that the solvent with PEI is not pressed properly into all layers and the quality of the product may be relatively low.

Step e) can for instance take place by heating the non-crimp fabric with solvent and PEI dissolved therein in an oven. After or during cooling and curing of the non-crimp fabric with PEI, the non-crimp fabric with PEI can be rolled onto a roll to enable easy storage and transport of the composite element.

The composite comprising the non-crimp fabric and PEI manufactured with the method according to the invention is also referred to as an NCF/PEI composite. Because PEI is a thermoplastic, an NCF/PEI composite is a so-called thermoplastic composite.

An embodiment of the method according to the invention further comprises the step, to be performed after step e), of:
g) pressing the non-crimp fabric with PEI or the element at increased temperature in order to flatten the non-crimp fabric with PEI or the element.

An NCF/PEI composite element with a flat surface is hereby obtained in simple manner.

The thickness of the fabric or element can also be set by performing step g).

The increased temperature preferably lies around or above the softening temperature of PEI. It is however also possible to perform step g) at a temperature below the softening temperature. The maximum temperature for performing step g) is the temperature at which degradation of PEI which is still acceptable takes place. Increased temperature is therefore understood here to mean a temperature suitable for performing step g), in particular a temperature lying a maximum of 70° C. below the softening temperature of PEI up to a maximum of the (acceptable) degradation temperature of PEI. The increased temperature lies in practical manner between about 140° C. and 360° C.

The non-crimp fabric with PEI can for instance be pressed immediately following step e), when it is still warm, wherein step f) takes place after step g) so that it is not necessary to heat the non-crimp fabric with PEI twice.

Alternatively, step g) can take place before step f), wherein the element is heated again. This is advantageous for instance when a number of elements obtained in step f) are pressed together in order to obtain a stiff composite plate.

The fibres are preferably chosen from the group comprising glass fibre, aramid fibre, carbon fibre and polyester fibre. Such fibres impart a strong reinforcement to the PEI.

Particularly glass fibre and carbon fibre produce an NCF/PEI composite having high temperature resistance, low flammability, good impact resistance and low moisture absorption.

In order to obtain a composite element which is strong and/or stiff in one direction and for instance resilient in other directions, the fibres in the non-crimp fabric can extend in one direction. Such a fabric is also referred to as a unidirectional fibre.

The non-crimp fabric can also comprise a number of layers, in each of which the fibres extend in one direction and wherein the fibres of the different layers extend in different directions. A stiff composite element is hereby obtained which has a relatively low weight. The fibres of the different layers can for instance be arranged at an angle of 45° to each other, wherein four layers are arranged on each other to obtain a composite element which is equally stiff and/or strong in substantially all directions. The directions of the fibres can be chosen subject to the desired load on the composite element.

It is noted that it may be the case that one layer at a time of the number of layers is formed with the method according to the invention, these layers being pressed together at increased temperature so as to obtain the composite element.

It may alternatively be the case that the non-crimp fabric of step a) has the number of layers. The number of layers of the fabric is in this case already mutually connected prior to step a), for instance by thread, and is seen in the sense of this invention as one layer of fabric which in accordance with the method according to the invention is impregnated (step c)), pressed (step d)) and heated (step e)) as one layer, and specifically not as a laminate of a number of layers which are separately impregnated and subsequently pressed together. An advantage of a non-crimp fabric having the number of layers in step a) is that there is a relatively small chance of for instance breakage or splitting of the fabric during manufacture of the composite element. It is an advantage of the method according to the invention that a non-crimp fabric with such a number of layers, which is therefore relatively thick, can be easily and/or properly impregnated with the PEI.

The solvent is preferably chosen from the group comprising n-methyl-2-pyrrolidone (NMP) and dimethylacetamide (DMAC).

Such solvents are relatively inexpensive and/or less harmful to the environment or people compared to other known solvents.

In an embodiment of the method according to the invention the quantity of solvent in the mixture of solvent with PEI dissolved therein amounts to a minimum of 50% by volume, a minimum of 55% by volume, a minimum of 60% by volume, a minimum of 65% by volume, a minimum of 70% by volume, a minimum of 75% by volume or a minimum of 80% by volume.

With such a minimum volume of solvent a good impregnation of the fabric can be provided, since at such a minimum volume of solvent the viscosity of the mixture of solvent and PEI dissolved therein is sufficiently low so that the mixture can flow relatively well into the fabric.

A ratio of PEI and solvent of 1 to 2.5 is found to be a particularly good one, this amounting to about 71% by volume of solvent.

Applicant has found that, with a view to the improved impregnation, the quantity of solvent in the mixture can even be chosen such that, after steps c) and d) have been performed, the fabric can comprise less PEI than is desirable. It can be advantageous for this purpose for the method to comprise the steps of repeating the steps c)-e) after performing the steps c)-e) and prior to step f) or after performing the steps c)-f). Following heating or cooling of the fabric the solvent with PEI dissolved therein is here once again arranged on the fabric, wherein the fabric is then pressed once again, wherein the fabric is subsequently heated once again and then optionally cools again. Relatively good impregnation of the PEI in the fabric hereby takes place twice, wherein the final quantity of PEI in the non-crimp fabric is as desired. This can increase the quality of the element.

Alternatively, the steps c) and d) can be repeated after performing the steps c) and d) and prior to steps e) and f). The solvent with PEI dissolved therein is arranged once again on the fabric here following pressing, wherein the fabric is subsequently pressed once again, wherein the fabric is then heated and subsequently cools.

The invention further relates to an element of composite material comprising a non-crimp fabric and polyetherimide (PEI) obtained by applying the method according to any of the foregoing claims, which element comprises a for instance plate-like or sheet-like body of PEI in which the non-crimp fabric is embedded as reinforcement.

Because of its properties such an element is suitable for diverse purposes such as, though not exclusively, for manufacturing components of vehicles such as cars, trucks, boats, aircraft, helicopters and space vehicles.

According to the invention the element of composite material comprising a non-crimp fabric and (PEI) can be manufactured as described above relatively inexpensively using the method according to the invention when compared to such an element of composite material manufactured by another method. This high-grade NCF/PEI composite manufactured with the method according to the invention is hereby suitable for applications in which cost is an important factor.

The element according to the invention can be modelled to any desired form, wherein modelling preferably takes place during heating.

The invention will be further elucidated with reference to figures shown in a drawing, in which:

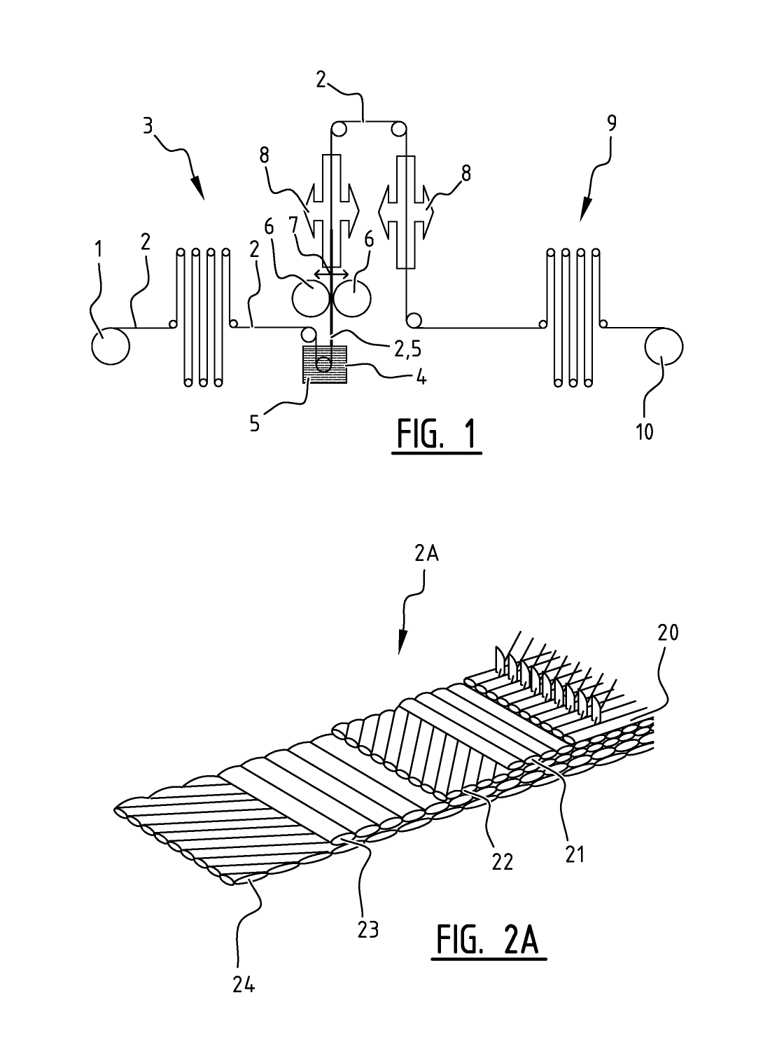

FIG. 1 shows schematically the method according to the invention; and

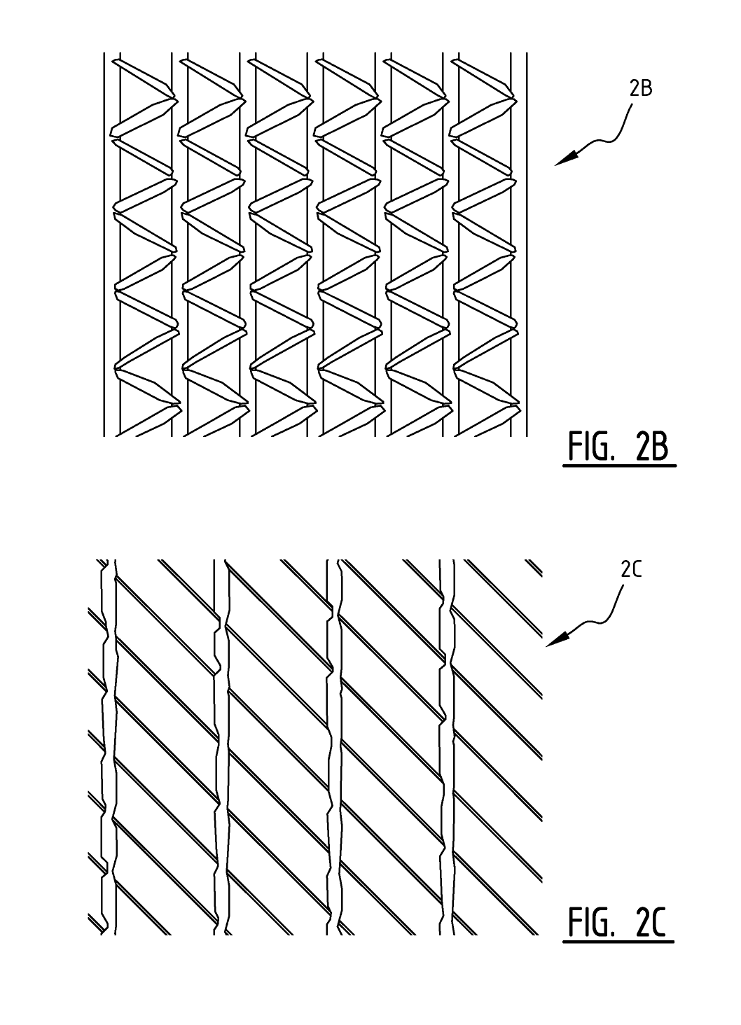

FIGS. 2A-2C each show a non-crimp fabric suitable for the method according to the invention.

FIG. 1 shows schematically the steps of the method for manufacturing an element of composite material according to the invention. Provided in a first step is a non-crimp fabric (NCF) 2 rolled onto a roll 1. The non-crimp fabric 2 is a fabric with mutually connected fibres of glass, aramid, carbon or polyester.

Non-crimp fabric 2 is subsequently drawn off the roll 1 and collected in a fabric buffer 3. Collecting a supply of non-crimp fabric 2 enables easy replacement of an empty roll by a fresh roll without the further process having to be halted. The process according to the invention can in this way take place continuously.

In a following step the non-crimp fabric 2 is pulled through a bath 4 filled with a mixture 5 of solvent with polyetherimide (PEI) dissolved therein, for instance by means of pulling rollers, so that the mixture 5 of solvent and PEI adheres to non-crimp fabric 2. Dissolving of the PEI in the solvent can for instance take place during heating or stirring, wherein bath 4 is filled with the mixture 5 after dissolving of the PEI in the solvent. The PEI is for instance in the form of a granulate, which granulate can dissolve easily in the solvent. The solvent is for instance n-methyl-2-pyrrolidone (NMP) and dimethylacetamide (DMAC).

In a subsequent step the non-crimp fabric 2 with the mixture 5 of solvent with PEI dissolved therein is carried through a pinch of two driven pressure rollers 6 disposed adjacently of each other, wherein the mixture 5 is pressed into non-crimp fabric 2. The two pressure rollers 6 are disposed here at a predetermined distance 7 from each other so that the non-crimp fabric 2 with mixture 5 has a predetermined thickness.

The non-crimp fabric 2 with the mixture 5 pressed into it is subsequently heated in an oven, wherein the solvent evaporates out of non-crimp fabric 2. The evaporation of the solvent is indicated in FIG. 1 with numeral 8.

The combination of non-crimp fabric 2 with the PEI is then collected in a second fabric buffer 9, after which the non-crimp fabric 2 is arranged on a roll 10. The second fabric buffer 9 here also provides the advantage that the process according to the invention can take place continuously without this process having to be halted during removal of a full roll 10 and arranging of a new empty roll. The non-crimp fabric 2 with the PEI cools in the second fabric buffer 9 in order to obtain a composite element.

The thus obtained composite element can optionally then be pressed at increased temperature for the purpose of flattening the element, or a number of thus obtained composite elements can be pressed together to obtain a stiff composite element (not shown).

FIGS. 2A-2C each show a type of non-crimp fabric 2A-2C. The non-crimp fabric 2A of FIG. 2A has four layers 20-24 arranged on each other, wherein the fibres of layers 20-24 extend in different directions. The fibres of the upper layer 20 extend here in the length of non-crimp fabric 2A, this direction being defined here as 0°. The fibres of the layer 21 extending immediately below layer 20 extend perpendicularly of the fibres of layer 20, or at an angle of 90°. The fibres of the layer 22 extending immediately below layer 21 extend at an angle of 45° to the fibres of layer 20. The fibres of the layer 23 extending immediately below layer 22 extend in the same direction as the fibres of layer 21, i.e. at an angle of 90° to the fibres of layer 20. The fibres of the lower layer 24 extend at an angle of −45° to the fibres of layer 20. The fibres of non-crimp fabric 2A are held together by a stitching thread. The arrangement of fibre layers 20-24 in four different directions (−45°, 0°, 45°, 90°,) is also referred to as quadraxial.

It is noted that the directions of the fibres of layers 20-24 can be chosen as desired, for instance subject to the desired load on the composite element. The fibres of all layers 20-24 can for instance be disposed in the lengthwise direction of non-crimp fabric 2A, so that a so-called unidirectional non-crimp fabric is obtained.

It is further noted that non-crimp fabric 2A can comprise any random number of fibre layers. Non-crimp fabric 2 can for instance comprise two layers disposed at respective angles of 0° and ±45°, or 0° and 90°, also referred to as biaxial. Alternatively, non-crimp fabric 2A can comprise three layers disposed at respective angles of 0°, ±45° and 90°, also referred to as triaxial.

FIG. 2B shows a non-crimp fabric 2B, all layers of which are disposed in one direction, i.e. in the lengthwise direction of non-crimp fabric 2B. The different fibre filaments of non-crimp fabric 2B are mutually connected by stitching thread.

FIG. 2C shows a non-crimp fabric 2C, the outer layer of which is disposed at an angle of 45°.

It is noted that the invention is not limited to the shown embodiments, but also extends to variants within the scope of the appended claims.

1. Method for manufacturing an element of composite material comprising a non-crimp fabric and polyetherimide (PEI), comprising the following steps, to be performed in suitable sequence, of:
a) providing a non-crimp fabric;
b) dissolving PEI in a solvent;
c) arranging the solvent with PEI dissolved therein on the non-crimp fabric;
d) pressing the solvent with PEI dissolved therein into the non-crimp fabric;
e) heating the non-crimp fabric for the purpose of evaporating the solvent, wherein the PEI remains behind in the non-crimp fabric; and
f) allowing the non-crimp fabric to cool and thus allowing the PEI to cure so as to obtain the element.

2. Method as claimed in claim 1, further comprising the step, to be performed after step e), of:
g) pressing the non-crimp fabric with PEI or the element at increased temperature in order to flatten the non-crimp fabric with PEI or the element.

3. Method as claimed in claim 1 or 2, wherein the fibres of the non-crimp fabric are chosen from the group comprising glass fibre, aramid fibre, carbon fibre and polyester fibre.

4. Method as claimed in any of the foregoing claims, wherein the fibres in the non-crimp fabric extend in one direction.

5. Method as claimed in any of the claims 1-3, wherein the non-crimp fabric comprises a number of layers, in each of which the fibres extend in one direction and wherein the fibres of the different layers extend in different directions.

6. Method as claimed in any of the foregoing claims, wherein the solvent is chosen from the group comprising n-methyl-2-pyrrolidone (NMP) and dimethylacetamide (DMAC).

7. Method as claimed in any of the foregoing claims, wherein the quantity of solvent in the mixture of solvent with PEI dissolved therein amounts to a minimum of 50% by volume, a minimum of 55% by volume, a minimum of 60% by volume, a minimum of 65% by volume, a minimum of 70% by volume, a minimum of 75% by volume or a minimum of 80% by volume.

8. Method as claimed in any of the foregoing claims, comprising of repeating the steps c)-e) after performing the steps c)-e) and prior to step f) or after performing the steps c)-f).

9. Method as claimed in any of the foregoing claims 1-8, comprising of repeating the steps c) and d) after performing the steps c) and d) and prior to the steps e) and f).

10. Element of composite material comprising a non-crimp fabric and polyetherimide (PEI) obtained by applying the method as claimed in any of the foregoing claims, which element comprises a for instance plate-like or sheet-like body of PEI in which the non-crimp fabric is embedded as reinforcement.
